(19) United States
(12) Patent Application Publication
(10) Pub. No.: US 2008/0201677 A1
(43) Pub. Date: Aug. 21, 2008

(54) Integrated Circuit (IC) Chip Input/Output (I/O) Cell Design Optimization Method And IC chip With Optimized I/O Cells

(76) Inventors: Faye Baker, Burlington, VT (US); Albert M. Chu, Essex, VT (US); Wai Ling Chung-Maloney, Waterbury Center, VT (US); Steven Voldman, South Burlington, VT (US)

Correspondence Address: LAW OFFICE OF CHARLES W. PETERSON, JR. BURLINGTON, 435B Carlisle Dr., Herndon, VA, 20170, US

(21) Appl. No.: 11/677,136

(22) Filed: Feb. 21, 2007

(51) Int. Cl. G06F 17/50

(52) U.S. Cl. 716/8

(57) ABSTRACT

A method of fabricating an integrated circuit (IC) chip. A standard cell macro (e.g., an Off Chip Interface (OCI) cell) is defined with circuit elements identified as in a macro domain. A variable macro boundary is defined for the standard cell macro. Shapes are selectively added to design layers in the macro boundary to occupy existing white space. Each supplemented layer is checked for technology rules violations in the macro boundary. Each layer is also checked for known sensitivities in the macro boundary.

### BACKGROUND OF THE INVENTION

1. Field of the Invention

The present invention is related to Integrated Circuit (IC) chip fabrication and more particularly to optimizing IC Input/Output (I/O) cells for improved chip manufacturability.

2. Background Description

A typical integrated circuit (IC) chip includes a stack of several sequentially formed layers of shapes, also known as mask levels. Each layer may be created or printed optically through well known photolithographic masking, developing and level definition, e.g., etching, implanting, deposition and etc. Shapes stacked on or overlaid on shapes on a prior layer define devices (e.g., field effect transistors (FETs)) and connect the devices into circuits. In a typical state of the art complementary insulated gate FET process, such as what is normally referred to as CMOS, device layers are formed on a surface layer of a wafer, e.g., a silicon surface layer of a Silicon On Insulator (SOI) wafer. Islands are defined by removing open or unpopulated areas of the silicon surface layer, for example, using Shallow Trench Isolation (STI). A simple FET is formed by the intersection of two shapes, a gate layer rectangle on a silicon island formed from the silicon surface layer.

A typical gate array, for example, includes a number of identical groups of devices or FETs, in what are known as cells. Logic cells are typically, centrally located in one or more cell arrays. Devices in each cell may be wired together in a simple logic block. Cells may be wired together into more complex logic function. Some larger groups of devices may be clustered together as macros. Ideally, fabrication parameters applied to features on a particular layer to affect all features uniformly on that layer, such that devices form uniformly. Unfortunately, all features do not respond uniformly.

Typically, each gate array has a number of fixed Input/Output (I/O) cells that are independent units with a predefined shape, form and function. In particular, a typical gate array chip footprint has several locations set aside for I/O cells with a fixed space (“one size fits all”) reserved. So, the space reserved for each I/O cell is determined by the predefined I/O cell shape for the largest I/O circuit in the gate array library. Typical I/O cells may have some densely populated levels, while other levels have large areas with nothing. Further, some I/O cells may have simple functions that may be implemented in much less area than others.

Locating a simple (smaller) I/O circuit in a larger I/O cell guarantees unused space with unpopulated or open areas in that I/O location. These large unpopulated or open areas are typically referred to as white areas. So, in a typical state of the art I/O cell the silicon layer is sparsely populated with isolated silicon island shapes surrounded by white space. Consequently, tuning shape formation for denser areas, e.g., in arrays, can cause these isolated shapes to distort, e.g., the shapes wash out. I/O Devices (FETs) formed from these washed out shapes have characteristics that do not match other chip devices and, typically, do not conform to design specifications.

Other levels may include isolated shapes in white areas as well, e.g., deep trenches (relatively narrow trenches that extend well into a silicon substrate below the SOI insulator layer) in the I/O areas. Deep trenches may be included in an I/O cell, for example, for capacitors, guard rings and/or electrostatic discharge (ESD) protect devices. Similarly, if an I/O cell does not include structures with deep trenches, placing the I/O cell adjacent to a memory array with deep trench storage capacitors, guarantees that trenches (at the edge of the array) have white space on at least one side. Because of this white space, these isolated deep trenches can fail to open or at least fail to open sufficiently to fill, e.g., with plate material for a deep trench capacitor. Further, other shape formation parameters, e.g., focus, focus angle and photoresist thickness uniformity may cause feature variations across the chip and wafer, i.e., Across Chip Linewidth Variation (ACLV). White spaces may exacerbate these variations in some locations and minimize them in others, further degrading ACLV. These unintended changes to I/O cell shapes may degrade the chip and

Thus, there is a need for white space compensation in gate array I/O cells.

### SUMMARY OF THE INVENTION

It is therefore a purpose of the invention to improve Integrated Circuit (IC) chip manufacturability;

It is another purpose of the invention to reduce white space effects in Input/Output cells;

It is another purpose of the invention to reduce white space effects in gate array chips, especially in gate array chip Input/Output cells.

The present invention is related to a method of fabricating an integrated circuit (IC) chip. A standard cell macro (e.g., an Off Chip Interface (OCI) cell) is defined with circuit elements identified as in a macro domain. A variable macro boundary is defined for the standard cell macro. Shapes are selectively added to design layers in the macro boundary to occupy existing white space. Each supplemented layer is checked for technology rules violations in the macro boundary. Each layer is also checked for known sensitivities in the macro boundary.

### BRIEF DESCRIPTION OF THE DRAWINGS

The foregoing and other objects, aspects and advantages will be better understood from the following detailed description of a preferred embodiment of the invention with reference to the drawings, in which:

FIG. 1A shows an example of an Integrated Circuit (IC) chip with representative logic/arrays and preferred Off Chip Interface (OCI) cells, compensated with densification shapes according to a preferred embodiment of the present invention.

FIG. 1B shows an example of a representation in more detail of an OCI cell, compensated with densification shapes.

FIG. 1C shows an example of a wafer with chips formed in multiple die locations according to a preferred embodiment of the present invention.

FIGS. 2A-C show an example of steps in defining an OCIB for each OCI cell at macro level, at chip level and at wafer level, respectively.

FIG. 3A-B show a flow diagram example of customizing the surface silicon layer (RX/STI) of the OCI and corresponding pseudo-code.

### DESCRIPTION OF PREFERRED EMBODIMENTS

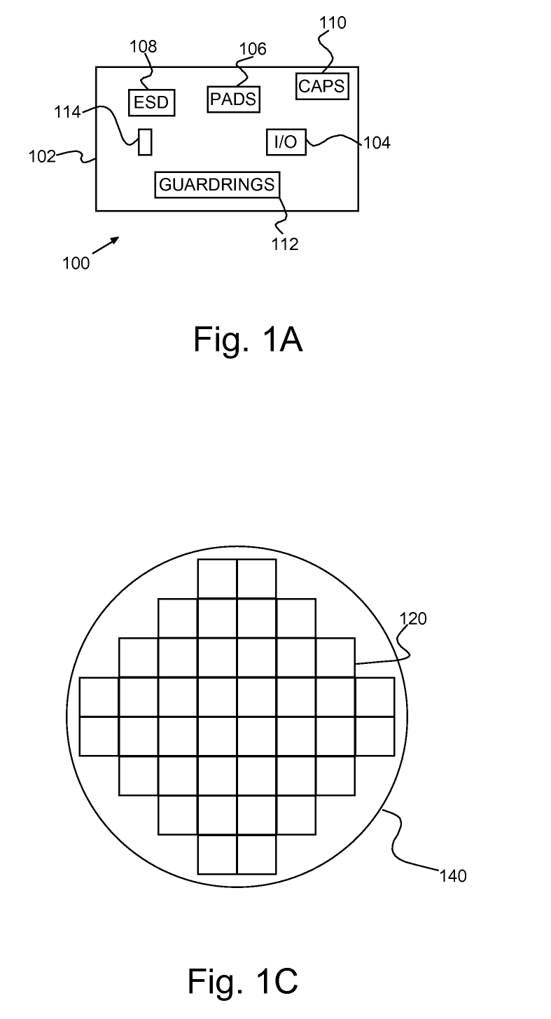

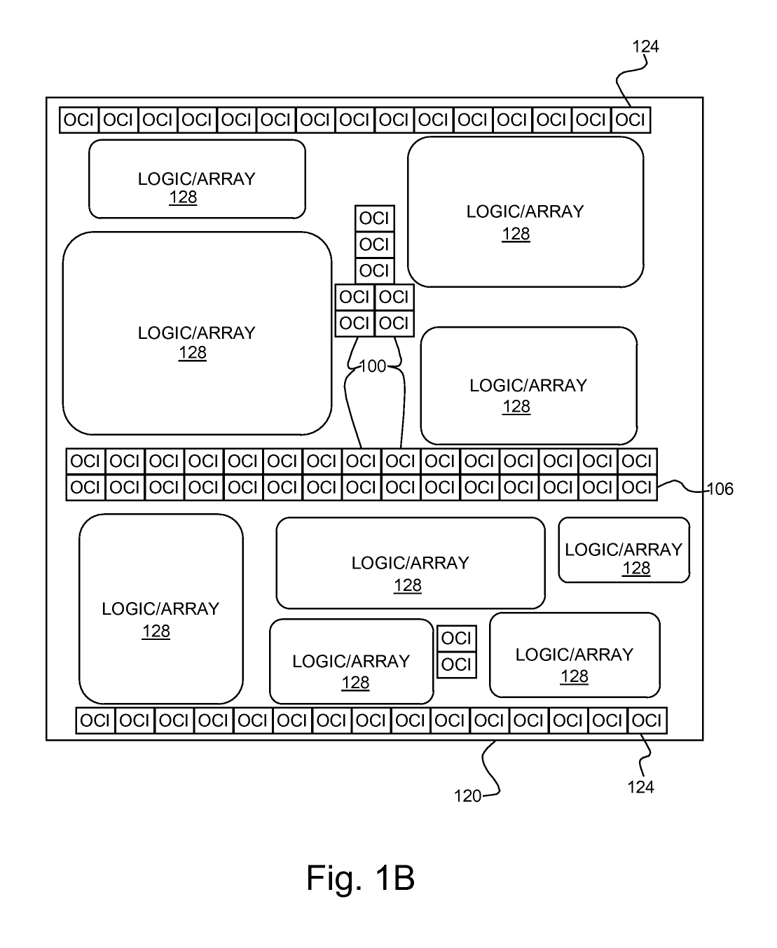

Turning now to the drawings, and more particularly, FIG. 1A shows an example of a preferred Off Chip Interface (OCI) cell 100; FIG. 1B shows an example of a preferred Integrated Circuit (IC) chip 120; and FIG. 1C shows an example of a wafer 140 with chips 120 formed in multiple die locations according to a preferred embodiment of the present invention. Unlike typical state of the art I/O cells, preferred OCI cells 100 do not have a predefined shape, form and function. Instead, an adjustable boundary (OCIB) 102 defines each OCI cell 100, which typically includes an Input/Output (I/O) circuit 104 (e.g., a receiver and/or an Off Chip Driver (OCD)). A typical OCI cell 100 may include one or more pads 106, an electrostatic discharge (ESD) protect device 108, capacitors 110 and a guard ring 112. Also, each OCI cell 100 may have one or more densification shapes 114 occupying what would otherwise be unusable silicon area or “white space.” Moreover, smaller, simple function OCI cells 100 that require less area to implement have densification shapes 114 occupying large such areas of white space.

As shown in the example of FIG. 1B, the IC chip 120 may have OCI cells 100 clustered in peripheral off chip banks 124, 126 or I/O surrounded by logic in logic/array 128. In particular, each OCI cell 100 may be optimized at each design level, i.e., at macro or cell 100 design, at chip 120 design and, finally, at wafer 140 level design. Further, where an OCI cell 100 is pre-optimized at macro level, the included densification shapes 114 compensate for placement relative to chip logic. In particular, these densification or optimization shapes 114 compensate for the effects or STI density/yield issues that would otherwise arise from inefficient silicon area use. It should be noted that although described herein with reference to compensating OCI cells, this is for example only. The present invention has application to any large footprint circuit or macro that is larger than a typical standard cell, such as, for example a phase locked loop (PLL) circuit or a digital locked loop (DLL) circuit.

The I/O circuit 104 connects off chip through one or more pad 106, e.g., for solder balls or wire bonds. The protect diode or electrostatic discharge (ESD) protect device 108 protects the chip 120 and, especially, the I/O circuit 104 from static discharges that might otherwise permanently damage the chip 120. Capacitors 110 provide local supply decoupling, improve ESD protect device 108 protection and may be provided for inclusion in the I/O circuit 104. Normally, the guard ring 112 surrounds the I/O circuit 104 and other OCI structures 106, 108 and 110. The guard ring 112 isolates the OCI 100 itself from other circuits and the rest of the chip structures from the OCI 100, e.g., from parasitic charge/current from electrostatic discharges that might be coupled into the OCI 100 from off chip. The OCI domain (OCID) includes any element necessary for forming the OCI 100, in this example the I/O circuit 104, chip pad(s) 106, the ESD protect device 108, capacitors 110 and OCI guard ring 112. It is understood that although represented in this example as a single off-chip circuit being included in each OCI cell 100, this is for example only. Each OCI cell 100 may include multiple off-chip circuits, each including an I/O circuit 104 and other OCI structures 106, 108 and 110, 112 and all encompassed by the OCIB 102.

Also, according to a preferred embodiment of the present invention, each OCI cell 100 may include densification or background optimizer (OCIO) shapes (e.g., 114) on one or more or all levels within its OCIB 102. These OCIO shapes 114 occupy white space on each layer in the OCIB 102. Typically, the densification shapes on each layer are between shapes in OCI 100 structures including the I/O circuit 104, the chip pad(s) 106, the ESD protect device 108, capacitors 110 and the guard ring 112.

Normally, other than the guard ring 112, each of the OCI 100 structures including the I/O circuit 104, the chip pad(s) 106, the ESD protect device 108, capacitors 110 do not have shapes on every chip layer. Instead, each OCI structure 104, 106, 108, 110 usually has one or more shapes occupying space on only a few levels. For a CMOS IC chip 100, for example, the I/O circuit 104 and the ESD protect device 108 may have shapes confined, primarily, to lower levels (e.g., to the lowest wiring level) with upper levels relatively free. Pads 106 and, possibly, capacitors 110 may be primarily in upper levels, i.e., above the lowest wiring level.

Thus, it is likely that at each level includes some white space within the OCIB 102, white space that is at least partially occupied by OCIO shapes 114. How that white space would otherwise normally affect each particular OCI cell 100 on any particular layer depends upon relatively close topological features. These close topological features may not be part of the particular OCI cell 100 itself, but in adjacent logic/arrays 122. As noted hereinabove, on the lowest (silicon) levels, white space may washout shapes that are isolated by Shallow Trench Isolation (STI) in otherwise isolated devices in the OCIB 102. However, with OCIO shapes 114 in the OCIB 102, those shapes are not so isolated. Similarly, because of white space in prior OCI cells, deep trenches (e.g., for forming Dynamic Random Access Memory (DRAM) storage capacitors) may not open at the edge of a DRAM array bordered by the OCI cells. Similarly, with OCIO shapes 114 (i.e., densification trench shapes) in the OCIB 102, those edge trenches are no longer edge trenches in a preferred chip.

Without the OCIO shapes 114, even if deep trenches form or devices do not wash out, shape variations may be such as to exceed Across Chip Line Variation (ACLV) targets. Excessive ACLV causes yield loss with circuits frequently failing in out of tolerance sites. Previous steps taken to counteract ACLV in logic/arrays 122 have degraded ESD protection and increased OCI 100 susceptibility to latch-up.

So, according to a preferred embodiment of the present invention, the aspect ratio is not fixed for all OCI cells (i.e., the OCIB may be different for each OCI cell) and each OCI cell 100 may include OCIO shapes 114 within its OCIB 102 on different layers. Thus, the present invention has application to customizing the physical layout of placed OCI cells 100 to self-compensate for effects of local geography. In particular, the OCIO shapes 114 self-compensate for local STI density as well as ACLV and STI topography issues, white space optimization, ESD, and latch-up. So, while each placed OCI cell 100 may have a different physical structure within its OCIB 102, all of the placed OCI cells 100 have substantially the same electrical characteristic.

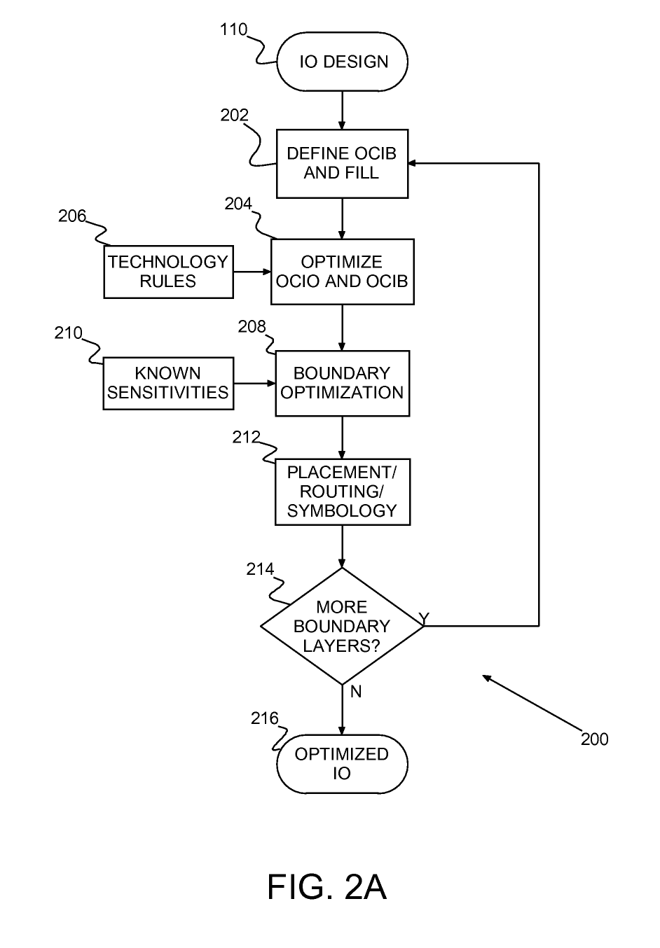

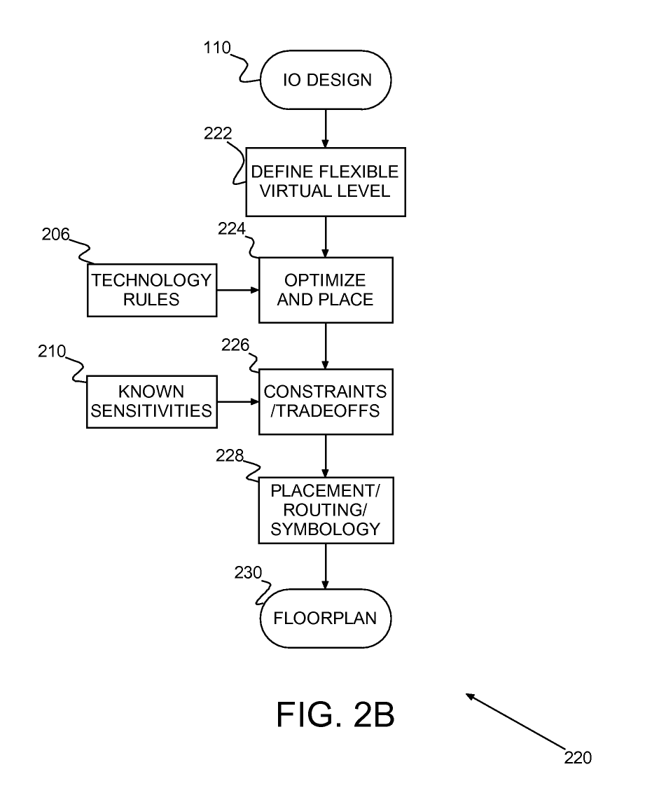

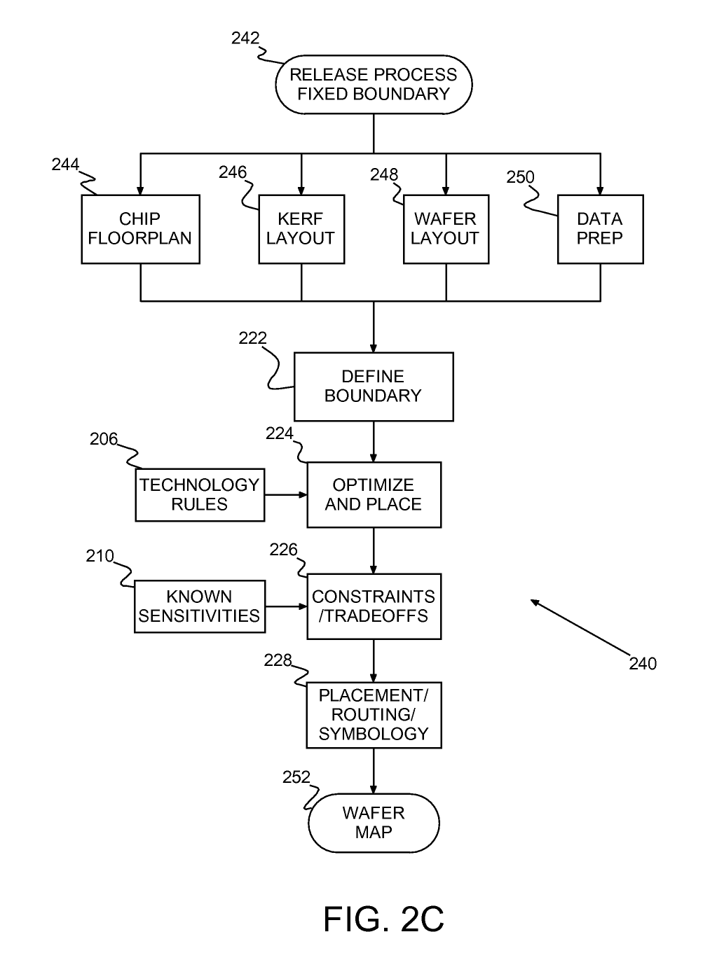

FIGS. 2A-C show an example of steps 200 in defining an OCIB 102 with appropriate densification shapes for each OCI cell at macro level (e.g., 100), at chip level (e.g., 120) and at wafer level, respectively, with reference to FIGS. 1A-C. Macro level OCIB 102 definition begins with an initial OCI cell 100 that includes at least the OCI domain. Then, in step 202 a “super I/O” cell is defined with an OCIB 102 that includes I/O circuits 104, ESD protect device 108, bond pad 106, guard ring 112 and OCIO shapes 114, e.g., logic gate array background cells. Typically, the I/O circuits 104, ESD protect device 108, bond pad 106 and guard ring 112 are at fixed relative locations to facilitate electrical analysis and characterization. The OCIO shapes 114 are placed around these OCID shapes to meet physical pad and aspect ratio requirements, i.e., whether inline or staggered. It should be noted that if the OCIO shapes 114 are logic gate array background cells, then the OCIB 102 may be expanded without impacting or reducing chip density.

In step 204, the initial OCI cell 100 is optimized for placement in standard chip floor plan and for routing, e.g., using a typical place and route design flow step. The optimization is based on appropriate circuit guidelines and technology specific files 206, e.g., process ground rules, Design For Manufacturability (DFM) guidelines and circuit timing specifications. Typically, this optimization 204 identifies rule violations and removes shapes to address those violations.

After optimizing for placement in step 204, design manufacturability analysis is applied to the cell design in step 208, e.g., in a layer by layer analysis. The design manufacturability analysis checks shapes on a particular layer for known design sensitivities for that layer. For the surface silicon layer (RX) in a Silicon On Oxide (SOI) wafer, for example, RX/STI is checked for white areas that are known to cause problems with both shallow trench isolation and with deep trench formation. So appropriate rules are provided in step 210, for example, for checking within the OCIB 102 the surface silicon layer (RX/STI), e.g., for white areas, for densification, for ACLV violations, for potential sources of ESD/latchup violations and guidelines. Shapes are added or removed to the OCIB 102 in any layer to address identified design sensitivities. Where shapes are added in checking step 208, preferably gate array cells are added to offset any identified problems, e.g., filling white areas. Optionally, if the added shapes are gate array cells, those added cells may be used for remaining logic cell placement.

In step 212 placement and wiring information is added (e.g., symbols identifying open channels that pass through the cell and connection points to cell I/O) to the modified OCI cell 100 with the OCIO shapes 114 and expanded OCIB 102. In step 214 the OCI cell 100 design is checked whether more layers remain for optimization mode and, if any remain, returning to step 202, the expanded OCIB 102 is taken as the boundary for checking the next layer of the modified OCI cell 100. Once all layers have been considered in step 214 or at least all layers of interest, then in step 216 modified OCI cell 100 has all features contained within the OCIB 102 and meets design specifications.

Once the OCIB 102 is customized to meet design specifications, customized OCIs 100 can be placed in a chip design, e.g., chip 120 in FIG. 1A. Since adjacent shapes depend upon cell placement, e.g., whether OCI cells 100 are clustered in peripheral off chip banks 124, 126 or individual OCI cells 100 or small groups are surrounded by logic in a logic/array 128. Once placed in a chip 120 and after wiring the chip 120, the OCIs 100 may be submitted to chip level OCIB 102 definition.

As noted hereinabove, FIG. 2B shows OCIB 102 definition at chip level 220, which is substantially similar to FIG. 2A with like steps labeled identically. Chip level definition 220 may be done instead of or sequentially, after macro level definition 200. Again OCIB 102 definition begins with in step 222 defining a “super I/O” cell around the initial OCI cell 100. In step 224 the initial OCI cells 100 are placed in standard chip floorplan (e.g., clustered in peripheral off chip banks 124, 126 or surrounded by logic in logic/array 128) and wiring is routed based on the placement. Place and wiring 224 is guided by appropriate chip level guidelines and technology specific files 206. After optimization for placement in step 224, chip design manufacturability analysis is applied in step 226. Chip design manufacturability checks chip shapes on all affected layers for known design sensitivities 210 for each of those layers. In step 228 placement and wiring information is added to the chip design, which is made available for review in step 230.

Similarly, FIG. 2C shows OCIB 102 definition at wafer level 240, e.g., for wafer scale integration, which is substantially similar to FIGS. 2A and B with like steps labeled identically. Wafer level definition 240 may be done instead of macro level definition 200 or sequentially, after chip level definition 220. Initially in step 242, the wafer design is released (for fabrication) with a common OCI 100 with a fixed boundary. In addition to logic design, the wafer design includes a chip floor plan 244; a kerf layout 246; a wafer layout 248 with a die pattern indicating the location of each chip on the wafer; and data preparation information 250. The kerf layout 246 is inserted between chip sites and may include, for example, test sites and alignment aids. For wafer scale integration, multiple designs are built on the same wafer, with the logic defined in the logic design and the location of each design assigned to one chip location, e.g., by a map in the wafer layout 248. The data preparation information 250 includes, for example, mask and etch biases that are to be applied to design shapes and dimensions to arrive at corresponding specified wafer shapes and dimensions.

Continuing this example, OCIB 102 definition begins with in step 222 defining a “super I/O” cell around the initial OCI cell 100. In step 224 the initial OCI cells 100 are placed in the standard chip floor plan (e.g., clustered in peripheral off chip banks 124, 126 or surrounded by logic in logic/array 128) and wiring is routed based on the placement. Place and wiring step 224 is guided by appropriate wafer level guidelines and technology specific files, typically similar to chip level guidelines and technology specific files 206. After optimization for placement in step 224, wafer design manufacturability analysis is applied in step 226, checking chip shapes on all affected layers for known design sensitivities 210. In step 228 placement and wiring information is added to the wafer design, which is made available for review in step 252.

Again, it should be noted that cell customization may be done serially or in a flat approach as describe for FIGS. 2A-C. Serial cell customization may entail defining a super cell and OICB 102 at cell/macro level 200, followed by chip level 220 and culminating with wafer level 240 with fewer and fewer changes occurring at each subsequent level.

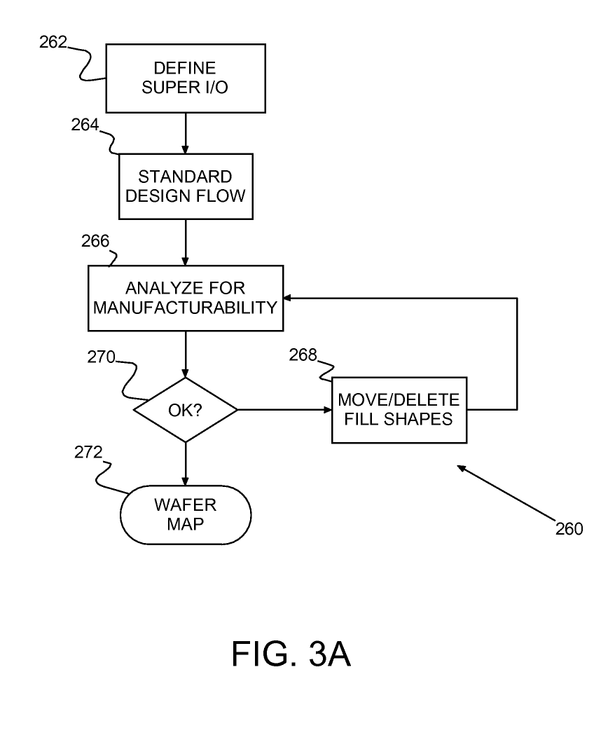

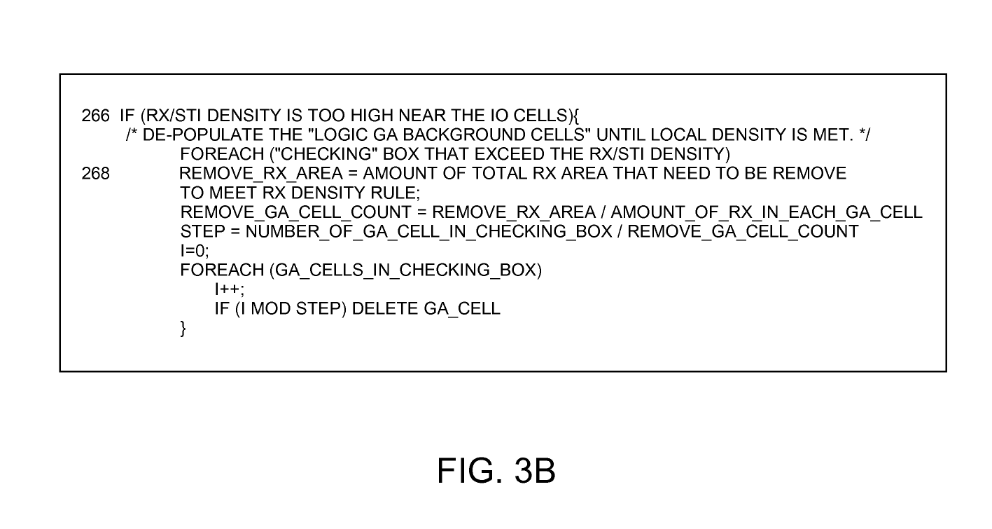

FIG. 3A shows a flow diagram 260 example of customizing the surface silicon layer (RX/STI) of the OCI 102 according to a preferred embodiment of the present invention and FIG. 3B shows corresponding pseudo-code. In this example, shapes are added to the surface silicon layer (RX/STI) to compensate, for example, for white areas, for densification, for ACLV violations, and for potential sources of ESD/latchup violations. In step 262 a super cell is defined for the silicon layer. The super cell includes shapes on the silicon layer that are required to form the I/O circuits (e.g., 104 in FIG. 2B), the ESD protect device 108, the guard ring 112 and any added OCIO shapes 114 included for meeting minimum density requirements. As noted hereinabove, preferably, the OCIO shapes 114 are logic gate array background cells. Also, since the bond pad 106 is normally on layers above the RX/STI layers and does not have a presence on those layers, the bond pad 106 is not part of the super cell for this layer. In step 264, the super cell is placed in a design, e.g., in a standard design flow. In step 266 the super cell is checked for manufacturability, i.e., whether as a result of placing the cell, surrounding shapes have made the super cell unmanufacturable, e.g., as a result of placement RX/STI density is too high near the IO cells. If so, the OCIO shapes 114 are selectively removed in step 268 (i.e., the logic gate array background cells are de-populated), repeatedly 270 until the super cell meets local density requirements 272.

Advantageously, a boundary layer (OCIB) is defined for customizing each I/O cell in both cell definition (size and aspect ratio) and content, with preferred embodiment I/O cells having white space in the boundary layer filled with prototype gate array shapes. Further, the boundary layer width may be adjusted based on density analysis both inside and outside of the boundary layer region. The boundary layer may be compressed (changing the aspect ratio of a particular OCI) to optimize shapes contained in the boundary layer to address process and device issues. Moreover, each OCI may have multiple individual virtual boundary layers (OCIBs), each defined based on physical phenomenon expected to be encountered for the particular design layer.

While the invention has been described in terms of preferred embodiments, those skilled in the art will recognize that the invention can be practiced with modification within the spirit and scope of the appended claims. It is intended that all such variations and modifications fall within the scope of the appended claims. Examples and drawings are, accordingly, to be regarded as illustrative rather than restrictive.

We claim:

1. A method of fabricating an integrated circuit (IC) chip, said method comprising the steps of:
defining a standard cell macro, said standard cell macro including a plurality of circuit elements in a macro domain;
defining a macro boundary for said standard cell macro;
selectively adding shapes to at least one layer of said standard cell macro in said macro boundary;
checking each said at least one layer of said standard cell macro for technology rules violations in said macro boundary; and
checking said each at least one layer of said standard cell macro for known sensitivities in said macro boundary.

2. A method as in claim 1, wherein said standard cell macro is an Off Chip Interface (OCI) cell.

3. A method as in claim 2, wherein the OCI cell Domain (OCID) comprises:
an Input/Output (I/O) circuit
a pad connected to said I/O circuit; and
an electrostatic discharge (ESD) protect device connected to said pad.

4. A method as in claim 2, wherein the step of selectively adding shapes comprises:
identifying white space in said at least one layer; and
inserting said shapes in said white space, wherein previously isolated device shapes on said at least one layer are bordered by added said shapes.

5. A method as in claim 4, wherein selectively added shapes comprise shapes in standard cell logic books.

6. A method as in claim 2, wherein said OCI cell is a placed OCI in a chip design, said shapes being added to said chip design.

7. A method as in claim 6, wherein said chip design is in a die location of a wafer, said shapes being added to said wafer.

8. A method as in claim 2, wherein when technology rules violations are identified as arising from an added shape in the step of checking for technology rules violations, said method further comprises removing said added shape.

9. A method as in claim 2, wherein when known sensitivities are identified as remaining in the step of checking for known sensitivities, said method further comprises adjusting said OCI boundary (OCIB) and adding one or more shape to said OCI in said OCIB.

10. A method of optimizing the physical design of Off Chip Interface (OCI) cell in an integrated circuit standard cell library, said method comprising the steps of:
providing an OCI cell including an OCI cell Domain (OCID), said OCID comprising:
an Input/Output (I/O) circuit,
a pad connected to said I/O circuit, and
an electrostatic discharge (ESD) protect device connected to said pad;
defining an OCI boundary (OCIB) encompassing said OCID;
selectively adding optimization shapes to at least one layer of said OCI cell in said OCIB;
checking each added shape for technology rules violations in said OCIB; and
checking said each layer of said OCI cell for known sensitivities in said OCIB.

11. A method as in claim 10, wherein the step of selectively adding optimization shapes comprises:
identifying white space in at least one layer; and
inserting said shapes in said white space, wherein previously isolated device shapes on said at least one layer are bordered by added said shapes.

12. A method as in claim 11 wherein selectively adding shapes comprises adding standard cell logic books.

13. A method as in claim 11, wherein said OCI cell is a placed OCI in a chip design, said shapes being added to said chip design.

14. A method as in claim 11, wherein said OCI cell is a placed OCI in a chip design, and said chip design is in a die location of a wafer, said shapes being added to said wafer.

15. A method as in claim 11, wherein when technology rules violations are identified as arising from an added optimization shape in the step of checking for technology rules violations, said method further comprises removing said added shape.

16. A method as in claim 11, wherein when known sensitivities are identified as remaining in the step of checking for known sensitivities, said method further comprises adjusting said OCIB and adding one or more shape in said OCIB.

17. A method of optimizing the physical design of an integrated circuit standard cell library element, the method comprising:
defining a geometric aspect ratio for the standard cell;
implementing a plurality of active circuit elements in the standard cell;
populating the standard cell with a plurality of supplemental circuit elements;
defining a circuit function for the standard cell;
modifying the aspect ratio based on a predetermined set of manufacturing criteria for a plurality of circuit layers in a specified process technology;
varying the number of supplemental circuit elements implemented in the standard cell to satisfy the manufacturing criteria;
placing the standard cell in an integrated circuit design; and
determining whether the physical design of the integrated circuit satisfies the predetermined set of manufacturing criteria.

18. A method as in claim 17, wherein said integrated circuit standard cell library element is an Off Chip Interface (OCI) cell and ones of said supplemental circuit elements are standard cell logic books.
